(19) United States
(12) Patent Application Publication
(10) Pub. No.: US 2002/0087385 A1
(43) Pub. Date: Jul. 4, 2002

(54) System and method for suggesting interaction strategies to a customer service representative

(76) Inventor: Perry G. Vincent, Irmo, SC (US)

Correspondence Address: JAMES M. STOVER, NCR CORPORATION, 1700 SOUTH PATTERSON BLVD, WHQ4, DAYTON, OH, 45479, US

(21) Appl. No.: 09/750,948

(22) Filed: Dec. 28, 2000

(51) Int. Cl. G06F 17/60

(52) U.S. Cl. 705/10

(57) ABSTRACT

A system and methods for suggesting interaction strategies to customer service representatives in a customer relationship management environment which includes analyzing customer data to determine one or more patterns and generating a set of rules based upon the patterns. A recommendation engine is used to compare the rules to a current customer interaction to recognize one or more of the patterns in the interaction. Real-time interaction strategies are then suggested which correspond to the recognized patterns.

### TECHNICAL FIELD

The present invention relates to a customer relationship management system and, more particularly, to the use of a rules engine to determine patterns in a customer's multi-channel interactions with a business and to suggest interaction strategies for a current interaction based upon the observed patterns.

### BACKGROUND OF THE INVENTION

A growing number of businesses utilize staffs of call center sales representatives, also know as customer service representatives, to accomplish customer sales and support functions via the telephonic media. Among the tasks accomplished by these customer service representatives are promoting product sales, complaint handling, product recommendations and customer service and support. In order to increase the value of these customer service representatives, businesses require desktop tools that can assist representatives having a variety of different skill levels. These desktop tools should assist the representatives in a number of different situations, and grow beginning representatives into experts, and provide expert representatives with timely information to close sales quickly.

Today, a number of internal business front office applications, such as, for example, Vantive, SilkNet, Siebel, ONYX and Clarify, exist for managing the internal operational aspects of a call center. These front office applications typically permit modifications to fields in internal customer databases, and provide a wide range of screens that appear on a representative's workstation display in real-time when a call is delivered to a representative, in order to provide the representative with a range of additional information about the potential customer. This additional information will often have been mined previously from a plurality of internal data stores and customer data bases, and analyzed in order to determine that most useful to the representative, such as customer preferences, marketing segments, and the like.

While front office applications are advantageous in that they provide a range of detailed data about each customer contact, they typically provide the representative with little or no summary or “processed” data about the customer's tendencies, behaviors or interests. Thus, while the representative may be able to learn a great deal about the customer's demographics and past product purchases, it is up to the individual representative, often at the time of the customer contact, to synthesize the data into a meaningful image of the customer and the particular sales or service approach to pursue during the interaction. Often, the representative must consult a number of different screens during the course of the customer interaction in order to synthesize the information into this meaningful image of the customer and their likely desires and needs. This need for the representative to review and comprehend customer data during the course of a call campaign reduces the efficiency of the representative. In addition, pertinent information may be inadvertently missed by the representative due to the need for speed and the oftentimes detailed manner in which the data is presented.

In addition to call centers, a number of self-service applications, such as kiosks and Internet web sites, are presently being utilized as “selling agents” for a business. These self-service applications access customer data from the internal data stores, and typically select a selling strategy based upon an analysis of past customer data. However, the data analyzed by these applications is usually restricted to data obtained through the specific channel being utilized, such as, for example, a web site.

Recommendation engines and collaborative filtering systems also exist for capturing Internet use and on-line purchasing data. The data captured by these systems is oftentimes used for generating personalized product or service recommendations while customers are online. These systems, however, have typically tracked only a single product attribute or entity, such as past product purchases, and have thus failed to provide a complete overview of a customer. Further, these systems have focused on customer interactions through only a single interaction channel, such as the Internet, and have therefore often missed the true scope of a customer's interactions with a business. Customer interactions typically occur over a much broader range of interaction channels than just the Internet, such as, for example, field sales calls, in-store visits, call center contacts, advertisement exposure, and the like. Thus, the failure of these systems to track information beyond a single channel limits the usefulness of the information obtained. In addition, since these systems have only been utilized for on-line transactions they have not been useable by businesses for a broader range of customer interactions, such as call center campaigns.

Accordingly, in order to have a more complete overview of customers and their purchasing habits, tendencies and behaviors it is desirable to have a system and method for observing and analyzing customer interactions across a variety of different types of interaction channels. Further, it is desirable to have a system and method for detecting patterns in the observed customer behaviors and purchases, and using the detected patterns to suggest strategies for managing a current interaction, either to a call center representative or directly to a customer through a self-service application.

### SUMMARY OF THE INVENTION

Accordingly, it is an object of the present invention to provide a system and method for recommending strategies for managing customer interactions in an automated customer relationship management environment.

In particular, it is a primary object of the present invention to provide a system and method for analyzing customer purchases and behaviors across a number of different types of interaction channels, detecting one or more patterns in the behaviors, and using the detected patterns to recommend strategies for managing a subsequent interaction.

It is another object of the present invention to provide such a system and method in which multiple dimensions of a customer's interaction with a business are analyzed, including past purchases, preferred purchase channels, timing between purchases and product affinities.

It is yet another object of the present invention to provide such a system and method which utilizes existing recommendation engine technologies to select and present customer interaction strategies.

It is a further object of the present invention to provide such a system and method in which interaction strategies are recommended in real-time based upon one or more aspects of the current interaction.

It is yet a further object of the present invention to provide such a system and method which analyzes customer data from both physical and virtual interaction channels.

It is a still further object of the present invention to provide such a system and method which can recommend strategies either to a business representative in a call center, or directly to a customer through a self-service application.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a method of suggesting an interaction strategy to a customer service representative in a customer relationship management environment is provided which includes analyzing customer data to determine one or more patterns, and generating a set of rules based upon the patterns. The rules are applied to current customer interactions to recognize one or more of the patterns in the interactions and to suggest interaction strategies corresponding to the recognized patterns.

In accordance with a second aspect, a system for recommending a strategy for managing a customer interaction is provided which includes a plurality of interaction channels for capturing customer data, and one or more data analysis tools comprising executable instructions for analyzing the customer data from the plurality of channels and determining one or more patterns from the data. A recommendation engine analyzes a current customer interaction to recognize one or more of the patterns in the interaction and to recommend strategies corresponding to the recognized patterns.

In accordance with a third aspect, a method of suggesting an interaction strategy to a customer service representative in an automated customer relationship management environment is provided which includes storing customer data from a plurality of different interaction sources, analyzing the customer data to determine one or more patterns, identifying a current customer interaction, and using a recommendation engine to detect affinities between the current customer interaction and the patterns. The recommendation engine recommends interaction strategies based on any detected affinities.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a block diagram of a system for suggesting interaction strategies according to the present invention; FIG. 2 is an exemplary screen display for presenting interaction strategies in accordance with the present invention; and

FIG. 3 is a flowchart of a process for suggesting interaction strategies.

### DETAILED DESCRIPTION OF THE PREFERRED EMBODIMENTS

Reference will now be made in detail to the present preferred embodiments of the invention, examples of which are illustrated in the accompanying drawings, wherein like numerals indicate the same elements throughout the views. As will be appreciated, the present invention, in its most preferred form, is directed to methods and systems for providing interaction guidance to a customer service representative based upon previously observed behavior patterns for the current customer contact, as well as input from the representative regarding the current interaction. One embodiment of the present invention is implemented using NCR Corporation's InterRelate+™ customer relationship management software, a commercially available recommendation or rules engine such as, for example, that provided by Net Perceptions, Inc. and various data analysis tools, such as, for example, those incorporated in NCR's Relationship Optimizer ™ marketing automation solution. The operating system environment is both Windows NT and Unix. Of course, other customer relationship management solutions, rules engines, data analysis techniques and operating systems (now known or hereinafter developed) may also be readily employed in the present invention without departing from the scope of the invention. Moreover, as one skilled in the art will readily appreciate, the client operating system environment may differ from the server operating system environment, and each of the various architectural components may have their own operating system environments.

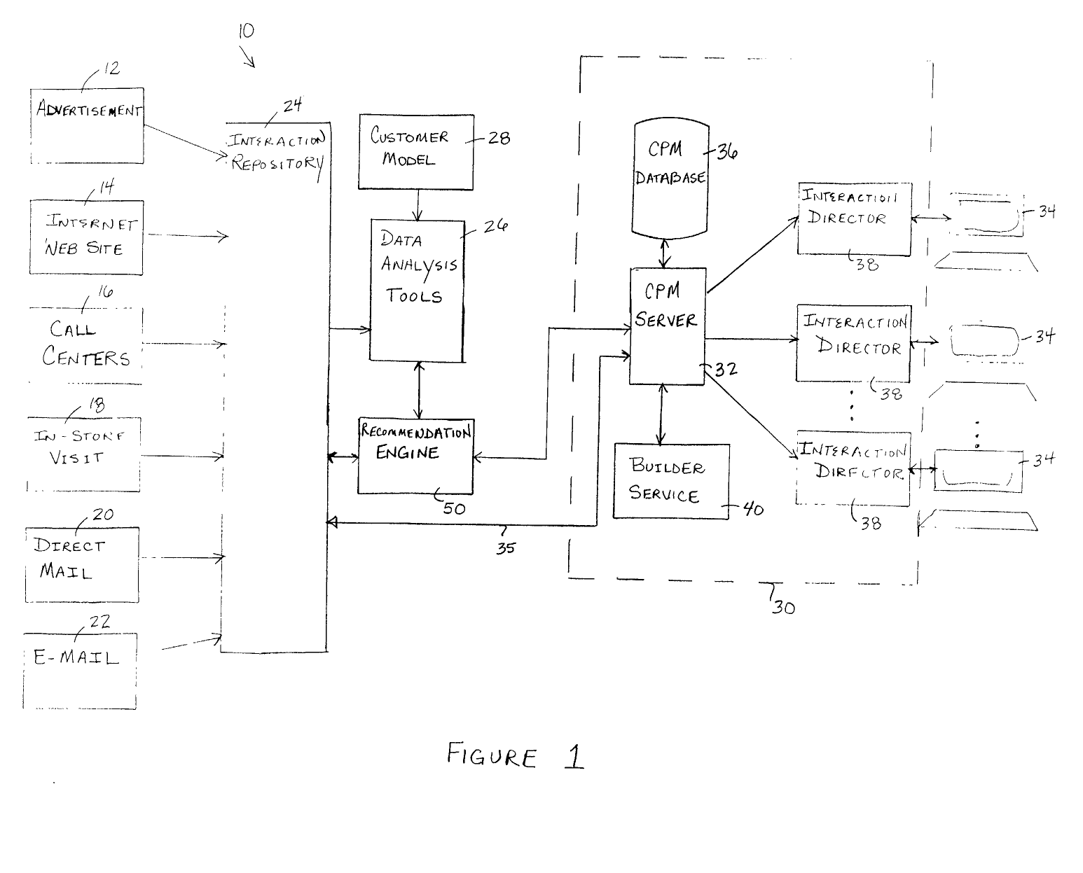

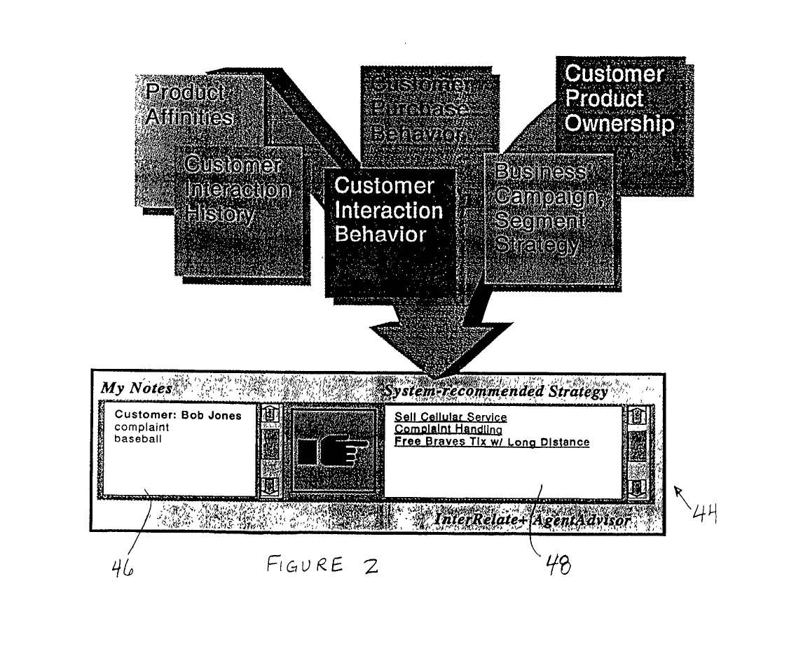

FIG. 1 illustrates a block diagram of an exemplary customer relationship management system 10 within which the present invention may be utilized. The system 10 is designed to enable a business to record, analyze and respond to customer interactions and behaviors in a personalized manner, in order to establish long-term relationships with its customers. As shown in FIG. 1, customer data is input to the system from a number of different interaction data sources. These data sources include, but are not limited to, advertisements 12, virtual interactions such as the businesses' web site(s) 14, or e-mail 22, call centers 16, in-store visits 18, and direct mailings 20. The interaction data from these sources is captured through one or more interaction channels or business systems, including front office applications, transaction handling systems, point-of-sale systems, Internet commerce applications and Computer Telephony Integration (CTI) software systems. Once captured, the data is stored by the business in a data store or interaction repository 24.

After customer data is captured through one or more of the interaction channels, data mining or analysis tools 26 are applied to the data in the interaction repository 24 to determine patterns of interaction behavior. The data analysis tools 26 are preferably developed solutions products which utilize sophisticated statistical algorithms and/or data models to analyze and predict customer behaviors based upon past actions and characteristics, or to determine market segmentation based upon past purchasing history and demographics. Preferably, one or more customer models 28 are derived by a business or marketing analyst for use by the data analysis tools 26 in determining the marketing segments and predicting customer behaviors. Using the models and algorithms, the data analysis tools 26 may determine, among other attributes, product affinities, namely, the relationship of a product or product line to another product, concept or customer attribute, and customer product ownership profiles, i.e. the set of products already owned by each individual customer plus the set of products that are likely to be complementary or needed based upon the customer's habits or attributes. For each owned product in the product ownership profile, the data analysis tools 26 preferably determine the length of time the customer has owned the product, or estimate the amount of time until the customer would likely purchase a replacement or replenishment product. For products not owned by the customer, the analysis tools track the customer's likelihood to purchase the product.

The data analysis tools 26 also preferably determine the behavior patterns of individual customers from the data captured and documented through each of the various interaction channels. These patterns may consist of the time between interactions with the business, the interaction channels used for particular types of purchases, and so forth. Examples of these types of behavior patterns include: customer interest-browse-purchase patterns, customer purchase-product channel patterns, and customer interest-business promotion patterns. The data analysis tools 26 are preferably applied against the interaction repository 24 on a periodic basis, such as daily, to rescore the customer data against the models, with the specific period for rescoring being based upon the needs of the business.

System 10 also includes a customer personalization management application, such as application 30 depicted in FIG. 1, to provide call center representatives with personalized information about each customer. An example of a suitable customer personalization management application for the present invention is NCR Corporation's InterRelate+ customer interaction solution, which utilizes the customer information captured through a number of different channels to provide call center representatives with real-time access to customer segmentation data and personalized assistance with customer interactions. In the preferred embodiment, the customer information and assistance from the personalization management solution is utilized in a call center environment to provide personalized data and suggested interaction approaches to a call center agent. However, the present invention may also be utilized in an alternative embodiment in which the personalized data and selected interaction strategies are presented to a customer in a self-service sales application, such as a kiosk or Internet web site. While the present invention will be described with respect to its application within the InterRelate+ solution, it is to be understood that the invention may be utilized in other customer personalization or relationship management applications, both now known and hereinafter developed, without departing from the scope of the invention.

As shown in FIG. 1, the customer personalization management application 30 includes a CPM server 32 for transferring data between a recommendation engine 50 and individual customer service representative workstations 34. The CPM server 32 receives the analyzed customer data from the recommendation engine 50 for use in personalizing the representatives' customer contacts. In addition, data gathered from the representative's customer interactions is summarized and uploaded to the interaction repository 24, as indicated by reference numeral 35, for use in refining the business's internal data store. The CPM server 32 is preferably connected to a CPM database 36, which functions as a central data store for configuration data, as will be described in more detail below. In addition to the CPM database 36, the CPM server 32 also interfaces with an Interaction Director 38, which executes on each workstation 34 and provides personalized screens on each workstation which correspond to the current customer contact.

The CPM server 32 also preferably interfaces with a configuration tool, such as the Builder Service 40 shown in FIG. 1, which functions as a primary configuration point for the application 30. Through the configuration tool, marketing personnel are able to configure the Interaction Director 38 to provide personalized presentations for each contacted customer based upon that customer's demographics or marketing segments, and also create personalized sales pitches or scripts for use by the customer service representative. The personalized presentations and scripts are stored as configuration data in the CPM database 36. During a customer interaction, the particular sales presentation and/or scripts to be utilized by the representative will be determined in real-time, based upon the customer information obtained from the recommendation engine 50.

As mentioned above, the Interaction Director 38 is a desktop application that executes at each workstation 34 to guide a representative through a personalized interaction with a customer. In the representative InterRelate+ application 30, the Interaction Director 38 is a tool-bar centered application from which a representative may launch “agent assistant” applications to direct the representative through the customer interaction. FIG. 2 depicts an exemplary screen 44 for an agent assistant application in accordance with the present invention. As shown in FIG. 2, the screen 44 includes a left-side panel 46 in which the customer service representative may enter notes regarding the interaction. These notes include information obtained from the customer during the presently occurring interaction, such as, for example, the type of service being requested, products being discussed, previous interactions mentioned by the customer, and so forth. The screen 44 also includes a right-side panel 48 in which are displayed system-recommended strategies for managing the customer interaction. These strategies typically encompass a broad range of topics, such as, for example, products to cross-sell, discounts to offer the customer, and steps for complaint handling, among others; and are developed from the interaction notes entered in the left-side panel 46, as will be described in more detail below. preferably, the various suggested strategies are summarized in the panel 48, such that the representative may select any one of the displayed strategies and receive a more detailed explanation of the proposed strategy in the panel.

As mentioned above, in the present invention system 10 includes a recommendation engine 50 for comparing data from current customer interactions with the previously detected behavior patterns and purchasing history identified by the analysis tools 26. The recommendation engine 50 interfaces with the analysis tools 26 and the customer personalization application 30, to suggest interaction strategies through the application based upon the previously detected customer patterns and purchase history. Recommendation engine 50 may be any suitable type of commercially available recommendation or rules engine, such as that developed and marketed by Net Perceptions, Inc. In the present invention, the recommendation engine 50 is “primed” with the results of the data analysis of the interaction repository 24, in order to recognize and act upon patterns in customer interactions. In order to recognize patterns of behavior in on-going interactions, the recommendation engine 50 generates a set of “rules” based upon the patterns determined by the data analysis. These rules may correspond to general behavior patterns, or may be particularized for each customer. When interaction notes are entered through the workstation panel 46, the recommendation engine 50 compares the notes in real-time with the previously developed rules. When a particular interaction or customer request follows one of the rules, a stratgy is suggested which corresponds to the rule.

For example, based upon past interaction history data in the repository 24, the data analysis tools 26 may have determined that Customer A has a pattern of resolving customer service issues through the business's Internet web site. When the event of Customer A contacting the business's call center by telephone is detected through the call center interaction channel, the recommendation engine 50 compares this action by Customer A with his past interaction history, in real-time, and determines that the usual behavior is for Customer A to conduct business on the web site. Therefore, the recommendation engine 50 may recommend a strategy to the call center representative of reminding Customer A to use the Internet site as a convenience. This strategy is presented to the representative on display panel 48 during the interaction, so that the representative may convey the information directly to Customer A

Similarly, a call center representative may be handling a service request with Customer B, and discussing baseball as the work order is being recorded. During this transaction, the representative may type “baseball” into the notes panel 46 on the workstation screen 44. The recommendation engine will evaluate this “baseball” notation, and may determine that the business presently has two promotions related to baseball that may be of interest to Customer B. Strategies related to these promotions will then be immediately displayed for the representative in panel 48. The representative may then select one of the strategies in order to be lead through a sales pitch presenting the baseball promotion to Customer B.

As mentioned above, the configuration tool 40 enables personalized scripts for the workstations 34 to be developed off-line and stored in the CPM database 36. Personalized scripts may be developed for a wide range of possible interaction strategies, so that when the recommendation engine 50 identifies a particular strategy for use with a customer, a corresponding script for the strategy may be uploaded from the CPM database 36 and presented to the representative.

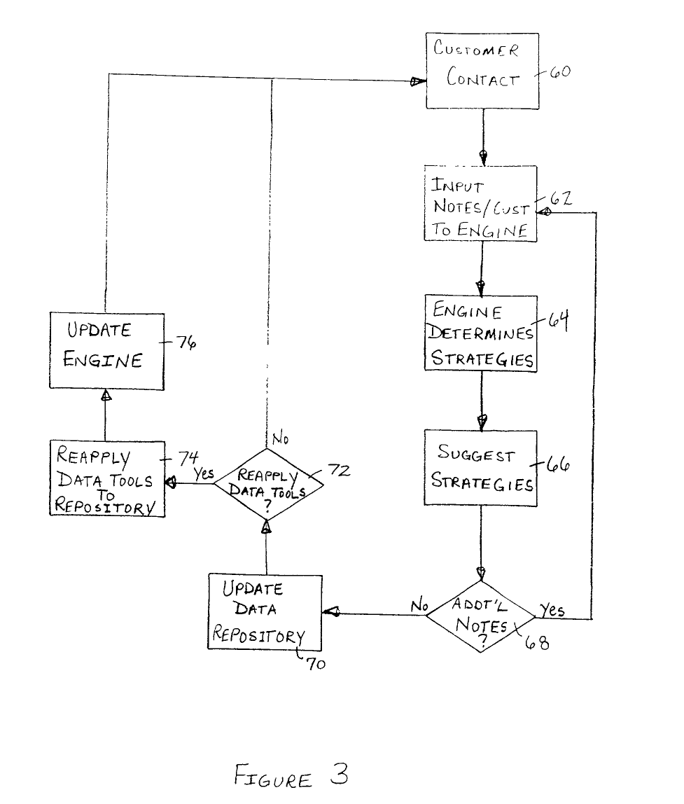

As mentioned above, the present invention may be utilized either in a call center environment or in a self-service application. In a self-service application, instead of reviewing notes entered by a representative, the recommendation engine 50 will analyze information entered by the customer in data fields offered through the web site, kiosk, or other device. The recommendation engine 50 will compare the entered information in real-time with the previously detected patterns and purchase history for the customer. The recommendation engine 50 will then suggest strategies, and previously developed scripts for each of the suggested strategies will be presented to the customer through the web site or other medium being utilized. FIG. 3 is a flow diagram depicting a process for recommending interaction strategies in accordance with the present invention. As shown in FIG. 3, at step 60 a customer interaction is initiated, with the customer being identified by a customer number or other identifying indicia. As a representative converses with the customer, the representative enters notes regarding the interaction in the workstation display panel 46, as shown at step 62. At step 64, the recommendation engine uses the representative's notes, along with the customer number and other interaction data, business data, and customer interaction behavior and history to determine one or more interaction strategies. The interaction strategies are presented to the representative on display 48 (or directly to the customer in a self-service application) at step 66. The recommendation engine then waits for additional information from the representative (or customer) at step 68. If additional information is entered in panel 46, then the process is returned to step 62, where the additional information is provided to the recommendation engine and additional strategies may be determined based on the new information.

If additional notes are not entered at step 68, and the interaction is ended, the process proceeds to step 70 where the interaction repository 24 is updated with data from the interaction. The schedule for rescoring the data repository 24 with the analysis tools 26 is checked at step 72. If it is time to rescore the repository 24, then the analysis tools 26 are reapplied to the updated data in the repository at step 74, and the recommendation engine is “reprimed” with any new or changed patterns or behaviors at step 76. The process then returns to step 60 for the next customer contact. If at step 72 it is determined that it is not time to rescore the repository, then the process proceeds directly back to step 60.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

What is claimed is:

1. A method of suggesting an interaction strategy to a customer service representative in a customer relationship management environment, said method comprising the steps of:
analyzing customer data to determine one or more patterns;
generating a set of rules based upon said patterns;
identifying a current customer interaction;
applying said rules to said current customer interaction to recognize one or more of said patterns in said interaction; and
suggesting an interaction strategy corresponding to said recognized patterns.

2. The method of claim 1, wherein said applying step further comprises inputting data from said current customer interaction and recognizing one or more of said patterns from said input data.

3. The method of claim 2, wherein said applying step further comprises using a recommendation engine to recognize said patterns in said input data.

4. The method of claim 3, wherein said recommendation engine recognizes said patterns from said input data in real-time.

5. The method of claim 1, wherein said customer data includes a customer interaction history with said business.

6. The method of claim 1, wherein said patterns are individually determined for customers of said business.

7. The method of claim 1, further comprising the step of capturing said customer data from a plurality of different interaction data sources.

8. The method of claim 7, wherein said interaction channels are both virtual and physical.

9. The method of claim 1, wherein said current customer interaction is a telephone contact with a call center representative.

10. The method of claim 1, wherein said current customer interaction is through a self-service application.

11. A system for recommending a strategy for managing a customer interaction, said system comprising:
a plurality of interaction channels for capturing customer data;
one or more data analysis tools comprising executable instructions for analyzing said customer data from said plurality of channels and determining one or more patterns from said data; and
a recommendation engine for analyzing a current customer interaction and recognizing one or more of said patterns in said interaction, said recommendation engine recommending strategies corresponding to said recognized patterns.

12. The system of claim 11, further comprising an interaction management application for directing said customer interaction, said application including a user interface for inputting data regarding said current interaction.

13. The system of claim 12, wherein said user interface includes a first display panel for inputting notes regarding said interaction and a second display panel for displaying recommended strategies from said recommendation engine.

14. The system of claim 13, wherein said recommendation engine uses said interaction notes to determine said recommended strategies.

15. The system of claim 11, further comprising a configuration tool for developing scripts corresponding to said recommended strategies.

16. A method of suggesting an interaction strategy to a customer service representative in an automated customer relationship management environment, said method comprising the steps of:
storing customer data from a plurality of different interaction sources;
analyzing said customer data to determine one or more patterns;
identifying a current customer interaction;
using a recommendation engine to detect affinities between the current customer interaction and said patterns; and
recommending an interaction strategy based on any detected affinities.

17. The method of claim 16, wherein said recommendation engine detects said affinities and recommends said interaction strategies in real-time.

18. The method of claim 17, wherein said recommendation uses a context of the current customer interaction to detect affinities to said patterns.

19. The method of claim 17, further comprising the step of inputting information from the current customer interaction and using said input information to detect affinities to said patterns.

20. The method of claim 16, wherein said patterns include customer product ownership, customer interaction history, customer interaction behavior, and product affinities.
